(19) United States
(12) Patent Application Publication
(10) Pub. No.: US 2024/0169269 A1
(43) Pub. Date: May 23, 2024

(54) DEPLOYING SIMPLIFIED MACHINE LEARNING MODELS TO RESOURCE-CONSTRAINED EDGE DEVICES

(71) Applicant: VIANAI SYSTEMS, INC., Palo Alto, CA (US)

(72) Inventors: Vishal Inder SIKKA, Los Altos Hills, CA (US); Navin BUDHIRAJA, Palo Alto, CA (US)

(21) Appl. No.: 18/511,951

(22) Filed: Nov. 16, 2023

Related U.S. Application Data
(60) Provisional application No. 63/426,666, filed on Nov. 18, 2022.

(51) Int. Cl. G06N 20/00

(52) U.S. Cl. CPC G06N 20/00

(57) ABSTRACT

One embodiment of a method for updating a simplified representation of a machine learning model includes receiving, from an edge device, data associated with execution of the simplified representation of the machine learning model on the edge device, performing one or more operations to re-train the machine learning model based on at least a portion of the data to generate a re-trained machine learning model, generating a simplified representation of the re-trained machine learning model, and transmitting, to the edge device, the simplified representation of the re-trained machine learning model for execution on the edge device.

### CROSS-REFERENCE TO RELATED APPLICATIONS

This application claims priority benefit of the United States Provisional Patent Application titled, “DEPLOYING AI MODELS TO RESOURCE-CONSTRAINED EDGE DEVICES,” filed on Nov. 18, 2022, and having Ser. No. 63/426,666. The subject matter of this related application is hereby incorporated herein by reference.

### BACKGROUND

### Field of the Various Embodiments

Embodiments of the present disclosure relate generally to computer science and machine learning and, more specifically, to techniques for deploying simplified machine learning models to resource-constrained edge devices.

### DESCRIPTION OF THE RELATED ART

Machine learning can be used to discover trends, patterns, relationships, and/or other attributes related to large sets of complex, interconnected, and/or multidimensional data. To glean insights from large data sets, regression models, artificial neural networks, support vector machines, decision trees, naïve Bayes classifiers, and/or other types of machine learning models can be trained using input-output pairs in the data. In turn, the discovered information can be used to guide decisions and/or perform actions related to the data.

Within machine learning, neural networks can be trained to perform a wide range of tasks with a high degree of accuracy. Neural networks are therefore becoming widely adopted in the field of artificial intelligence. Neural networks can have a diverse range of network architectures. In more complex scenarios, the network architecture for a neural network can include many different types of layers with an intricate topology of connections among the different layers. For example, some neural networks can have ten or more layers, where each layer can include hundreds or thousands of neurons and can be coupled to one or more other layers via hundreds or thousands of individual connections.

Edge devices are computing devices that are located close to the “edge” of a network, which is typically at or near locations where data is collected and/or consumed. One example of an edge device is a wearable device that is equipped with sensors to monitor various health metrics, such as the heart rate, steps taken, and sleep patterns of a user wearing the wearable device. The wearable device can also include computing capabilities that permit the wearable device to process acquired sensor data and provide real-time feedback (e.g., a tracked activity, heart rate, sleep analysis, etc.) to the user. Another example of an edge device is an intelligent vehicle headlight that is equipped with a camera and includes computing capabilities. The intelligent vehicle headlight can process images that are acquired by the camera and adjust the brightness of the headlight based on the processing results.

One drawback of edge devices is that, as a general matter, edge devices have significant resource constraints, such as limited computational resources and power constraints. Conventional machine learning models, including neural networks, can be computationally expensive to run and/or consume significant amounts of power. Oftentimes, these types of machine learning models cannot be deployed to run on edge devices that are resource constrained. Even if a machine learning model were deployed to run on an edge device, few, if any, conventional approaches exist for updating the machine learning model after the initial deployment to keep that machine learning model up to date.

As the foregoing illustrates, what is needed in the art are more effective techniques for deploying machine learning models to run on edge devices and updating the deployed machine learning models.

### SUMMARY

One embodiment of the present disclosure sets forth a computer-implemented method for updating a simplified representation of a machine learning model. The method includes receiving, from an edge device, data associated with execution of the simplified representation of the machine learning model on the edge device. The method further includes performing one or more operations to re-train the machine learning model based on at least a portion of the data to generate a re-trained machine learning model. The method also includes generating a simplified representation of the re-trained machine learning model. In addition, the method includes transmitting, to the edge device, the simplified representation of the re-trained machine learning model for execution on the edge device.

Other embodiments of the present disclosure include, without limitation, one or more computer-readable media including instructions for performing one or more aspects of the disclosed techniques as well as one or more computing systems for performing one or more aspects of the disclosed techniques.

One technical advantage of the disclosed techniques relative to the prior art is that the simplified machine learning models require less computational resources and can, therefore, run on edge devices. The simplified machine learning models also do not have significantly reduced performance relative to the performance of the original machine learning models. In addition, the disclosed techniques permit the lifecycles of simplified machine learning models to be managed, including updating the simplified machine learning models and deploying the updated simplified machine learning models to edge devices. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of various embodiments.

FIG. 2 is a more detailed illustration of one of the compute nodes of FIG. 1, according to various embodiments.

FIG. 3 is a more detailed illustration of the processing engine of FIG. 1, according to various embodiments.

FIG. 4 is a more detailed illustration of the training engine of FIG. 3, according to various embodiments.

FIG. 5 is a more detailed illustration of the edge device of FIG. 1, according to various embodiments.

FIG. 6 illustrates how a machine learning model can be simplified, according to various embodiments.

FIG. 7 sets forth a flow diagram of method steps for acquiring data to re-train a machine learning model, according to various embodiments.

FIG. 8 sets forth a flow diagram of method steps for updating a simplified machine learning model on an edge device, according to various embodiments.

FIG. 9 sets forth a flow diagram of method steps for simplifying a machine learning model, according to various embodiments.

### DETAILED DESCRIPTION

In the following description, numerous specific details are set forth to provide a more thorough understanding of the various embodiments. However, it will be apparent to one of skill in the art that the inventive concepts can be practiced without one or more of these specific details.

### System Overview

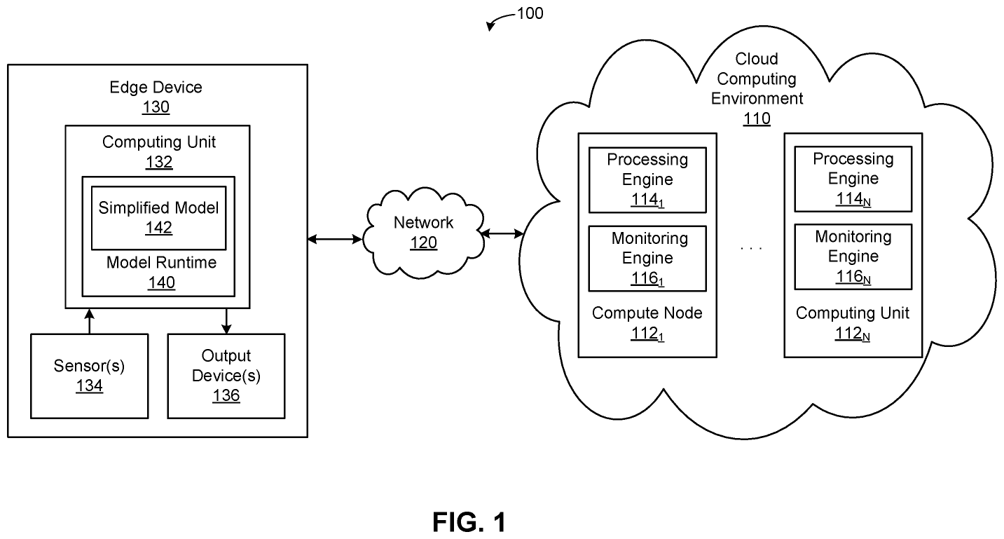

FIG. 1 illustrates a system 100 configured to implement one or more aspects of the various embodiments. As shown, system 100 includes a cloud computing environment 110 that is in communication with an edge device 130 over a network 120. Network 120 can be a wide area network (WAN) such as the Internet, a local area network (LAN), or any other suitable network.

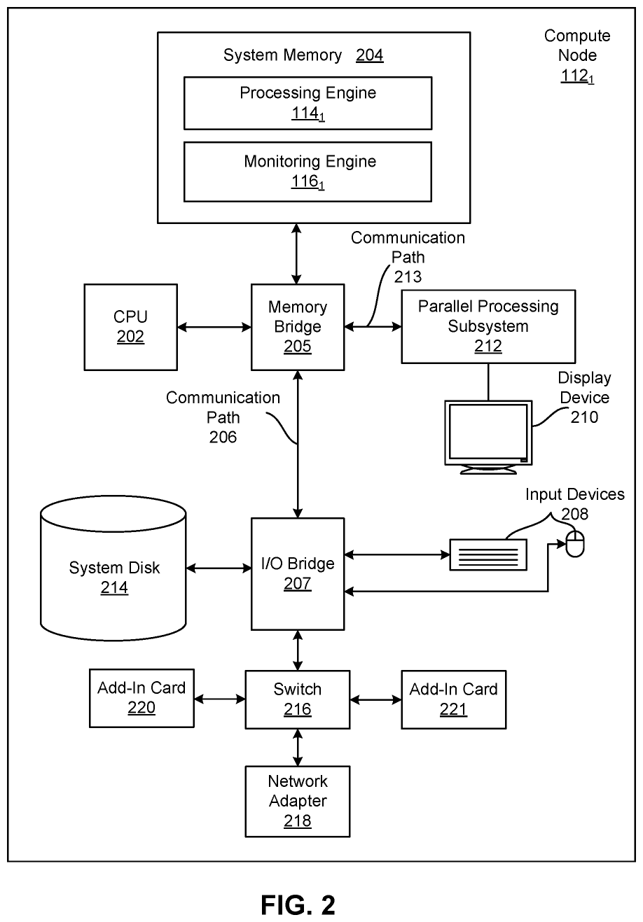

As shown, cloud computing environment 110 includes a network of interconnected compute nodes 112_{1-N} (referred to herein collectively as compute nodes 112 and individually as a compute node 112) that receive, transmit, process, and/or store data. In some embodiments, compute nodes 112 can include any technically feasible combination of software, firmware, and hardware. Compute nodes 112 can provide any suitable compute, storage, and/or other processing services in some embodiments. Further, compute nodes 112 can be co-located or physically distributed from one another. For example, compute nodes 112 could include one or more general-purpose personal computers (PCs), Macintoshes, workstations, Linux-based computers, server computers, one or more server pools, or any other suitable devices. The components of compute node 112₁ are discussed below in conjunction with FIG. 2, and the other compute nodes 112 can include similar components. Any suitable applications can access the cloud computing environment 110 in some embodiments.

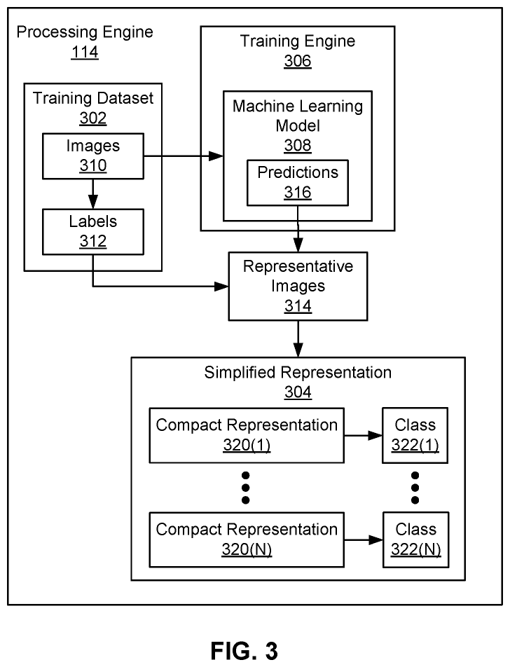

As shown, each compute node 112_{1-N} includes a respective processing engine 114_{1-N} (referred to herein collectively as processing engines 114 and individually as a processing engine 114) and monitoring engine 116_{1-N} (referred to herein collectively as monitoring engines 116 and individually as a monitoring engine 116). In some embodiments, the processing engines 114 are configured to generate, update, and deploy simplified machine learning models to edge devices (e.g., edge device 130), as discussed in greater detail below in conjunction with FIGS. 3-6 and 8-9. In some embodiments, the monitoring engines 116 are configured to monitor the performance of simplified machine learning models that have been deployed, as discussed in greater detail below in conjunction with FIGS. 3-6 and 8-9. Although multiple processing engines 114 and monitoring engines 116 that execute on different compute nodes 112 are shown for illustrative purposes, in some embodiments, a single processing engine and/or a single monitoring engine can be used, and/or multiple processing engines and/or monitoring engines can execute on a single compute node.

The computing devices and cloud computing environment 110 of FIG. 1 can be modified as desired in some embodiments. Further, the functionality included in any of the applications 112 can be divided across any number of applications or other software that are stored and executed via any number of devices that are located in any number of physical locations.

Edge device 130 is a computing device that can be located close to the “edge” of a network, which can be at or near a location where data is collected and/or consumed. One example of an edge device is a wearable device that is equipped with sensors to monitor various health metrics and computing capabilities. Another example of an edge device is an intelligent vehicle headlight that is equipped with a camera and includes computing capabilities. Further examples of edge devices include sensors (e.g., cameras) that include computing capabilities and machines (e.g., industrial controllers, rigs, robots, assembly line equipment, vehicles, airplanes, rockets, medical devices, etc.) or components thereof that include computing capabilities. Although a single edge device 130 is shown for illustrative purposes, cloud computing environment 110 can communicate with any number of edge devices in some other embodiments.

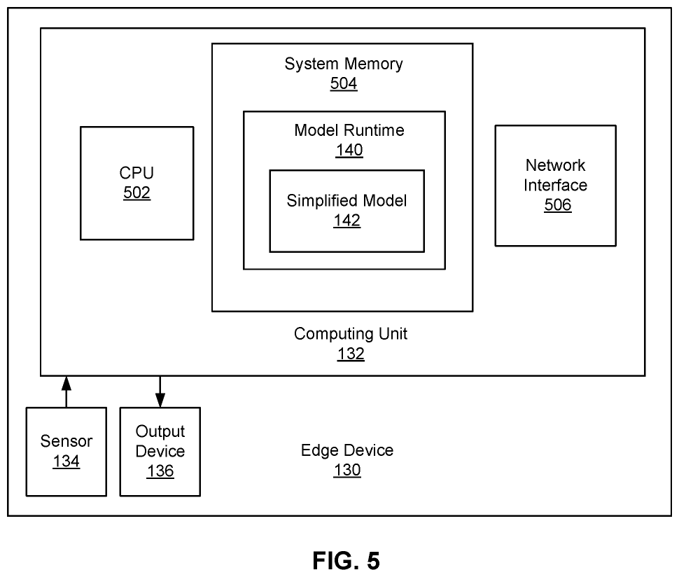

As shown, edge device 130 includes a computing unit 132, one or more sensors 134, and one or more output devices 136. The components of edge device 130 are discussed in greater detail below in conjunction with FIG. 5. Illustratively, a model runtime application (“model runtime”) 140 that includes a simplified machine learning model (“simplified model”) 142 executes on a processor (not shown) of the computing unit 132 and is stored in a system memory (not shown) of the computing unit 132. Simplified machine learning model 142 is a simplified representation of a machine learning model that is generated by one or more of processing engines 114 and deployed to edge device 130 for execution by model runtime 140. Techniques for generating simplified machine learning models and managing lifecycles of the same are discussed in greater detail below in conjunction with FIGS. 3-9.

Each sensor 134 can include any device or component configured to detect, measure, or respond to physical, chemical, or biological changes or inputs in an environment. Examples of sensors include cameras, LIDAR (Light Detection and Ranging) sensors, radar, microphones, etc. Each output device 136 can include a hardware system or device configured to convey information, data, or results to the user or another system in a tangible or perceivable form like displays and controllers. Examples of output devices include display devices, speakers, lights, etc. In some embodiments, model runtime 140 executes simplified machine learning model 142 to process sensor data acquired by sensor(s) 132 and causes actions, such as controlling output device(s) 136, to be performed based on output of the simplified machine learning model 142. For example, assume the edge device 130 is an intelligent vehicle headlight, the sensor(s) 134 include a camera, and the output device(s) 136 include a headlight. In such a case, the camera can acquire images that model runtime 140 processes using simplified machine learning model 142 to detect objects in the images. Based on the detected objects, model runtime 140 or another application can adjust the brightness of light that is emitted by the headlight. As another example, assume the edge device 130 is a machine, such as an industrial controller, rig, robot, assembly line equipment, vehicle, airplane, rocket, medical device, or the like. In such a case, sensor data acquired by the machine can be processed by model runtime 140 using simplified machine learning model 142 to control the machine, predict failure of the machine, etc. In addition, in some embodiments, model runtime 140 stores a log of the acquired sensor data and information on unusual situations that are encountered during execution of simplified machine learning model 140, and model runtime 140 transmits the log and unusual situation information to (1) one or more of processing engines 114 for use in updating simplified machine learning model 140, and/or (2) one or more of monitoring engines 116 for use in monitoring the performance of simplified machine learning model 140, as discussed in greater detail below in conjunction with FIGS. 3-9.

It should be noted that the system 100 described herein is illustrative and that any other technically feasible configurations fall within the scope of the present disclosure. For example, in some embodiments, multiple instances of processing engines 114 and/or monitoring engines 116 can execute together or separately on a server or set of nodes in a data center, cluster, or cloud computing environment to implement the functionality of cloud computing environment 110. As another example, one or more of processing engines 114 and/or monitoring engines 116 could be distributed across one or more hardware and/or software components or layers.

FIG. 2 illustrates in greater detail compute node 112₁ of FIG. 1, according to various embodiments. In some embodiments, each of the other compute nodes 112 can include similar components as compute node 112₁. As shown, compute node 112₁ includes, without limitation, a central processing unit (CPU) 202 and a system memory 204 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In operation, I/O bridge 207 is configured to receive user input information from one or more input devices 208, such as a keyboard, a mouse, a joystick, etc., and forward the input information to CPU 202 for processing via communication path 206 and memory bridge 205. Switch 216 is configured to provide connections between the I/O bridge 207 and other components of compute node 112₁, such as a network adapter 218 and various add-in cards 220 and 221. Although two add-in cards 220 and 221 are illustrated, in some embodiments, compute node 112₁ can only include a single add-in card.

As also shown, I/O bridge 207 is coupled to a system disk 214 that can be configured to store content, applications, and data for use by CPU 202 and parallel processing subsystem 212. As a general matter, system disk 214 provides non-volatile storage for applications and data and can include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. Finally, although not explicitly shown, other components, such as universal serial bus or other port connections, compact disc drives, digital versatile disc drives, movie recording devices, and the like, can be connected to I/O bridge 207 as well.

In various embodiments, memory bridge 205 can be a Northbridge chip, and I/O bridge 207 can be a Southbridge chip. In addition, communication paths 206 and 213, as well as other communication paths within compute node 112₁, can be implemented using any technically suitable protocols, including, without limitation, AGP (Accelerated Graphics Port), Hyper Transport, or any other bus or point-to-point communication protocol known in the art.

In some embodiments, parallel processing subsystem 212 comprises a graphics subsystem that delivers pixels to a display device 210 that can be any conventional cathode ray tube, liquid crystal display, light-emitting diode display, or the like. In such embodiments, parallel processing subsystem 212 incorporates circuitry optimized for graphics and video processing, including, for example, video output circuitry. Such circuitry can be incorporated across one or more parallel processing units (PPUs) included within parallel processing subsystem 212. In other embodiments, parallel processing subsystem 212 incorporates circuitry optimized for general purpose and/or compute processing. Again, such circuitry can be incorporated across one or more PPUs included within parallel processing subsystem 212 that are configured to perform such general purpose and/or compute operations. In yet other embodiments, the one or more PPUs included within parallel processing subsystem 212 can be configured to perform graphics processing, general purpose processing, and compute processing operations.

In various embodiments, parallel processing subsystem 212 can be or include a graphics processing unit (GPU). In some embodiments, parallel processing subsystem 212 can be integrated with one or more of the other elements of FIG. 2 to form a single system. For example, parallel processing subsystem 212 can be integrated with CPU 202 and other connection circuitry on a single chip to form a system on chip (SoC).

In some embodiments, CPU 202 is the master processor of the policy generating server 110, controlling and coordinating operations of other system components. Although one CPU 202 is shown for illustrative purposes, a compute node can include multiple CPUs or other types of processors in some embodiments. In some embodiments, CPU 202 issues commands that control the operation of PPUs. In some embodiments, communication path 213 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

System memory 204 can be any type of memory capable of storing data and software applications, such as a random access memory (RAM), a read-only memory (ROM), an erasable programmable read-only memory (EPROM or Flash ROM), or any suitable combination of the foregoing. In some embodiments, a storage (not shown) can supplement or replace the system memory 204. The storage can include any number and type of external memories that are accessible to the CPU 202 and/or the GPU. For example, and without limitation, the storage can include a Secure Digital Card, an external Flash memory, a portable compact disc read-only memory (CD-ROM), an optical storage device, a magnetic storage device, or any suitable combination of the foregoing. In some embodiments, system memory 204 can include at least one device driver configured to manage the processing operations of the one or more PPUs within parallel processing subsystem 212. In addition, system memory 204 stores processing engine 114₁ and monitoring engine 116₁, described above in conjunction with FIG. 1.

It will be appreciated that the system shown herein is illustrative and that variations and modifications are possible. The connection topology, including the number and arrangement of bridges, the number of CPUs, and the number of parallel processing subsystems, can be modified as desired. For example, in some embodiments, system memory 204 could be connected to CPU 202 directly rather than through memory bridge 205, and other devices would communicate with system memory 204 via memory bridge 205 and CPU 202. In other alternative topologies, parallel processing subsystem 212 can be connected to I/O bridge 207 or directly to CPU 202, rather than to memory bridge 205. In still other embodiments, I/O bridge 207 and memory bridge 205 can be integrated into a single chip instead of existing as one or more discrete devices. In some embodiments, any combination of CPU 202, parallel processing subsystem 212, and system memory 204 can be replaced with any type of virtual computing system, distributed computing system, or cloud computing environment, such as a public cloud, a private cloud, or a hybrid cloud. Lastly, in certain embodiments, one or more components shown in FIG. 2 may not be present. For example, switch 216 could be eliminated, and network adapter 218 and add-in cards 220, 221 would connect directly to the I/O bridge 207.

### Deploying Simplified Machine Learning Models to Edge Devices

FIG. 3 is a more detailed illustration of a processing engine 114 of FIG. 1, according to various embodiments. As shown, processing engine 114 is configured to generate a simplified representation 304 of a trained machine learning model 308. Simplified representation 304 of machine learning model 308 is also referred to herein as “simplified model 304” or “simplified machine learning model 304.” Machine learning model 308 includes a number of learnable parameters and an architecture that specifies an arrangement, a set of relationships, and/or a set of computations related to the parameters. For example, machine learning model 308 could include one or more recurrent neural networks (RNNs), convolutional neural networks (CNNs), deep neural networks (DNNs), deep convolutional networks (DCNs), and/or other types of artificial neural networks or components of artificial neural networks. Machine learning model 308 could also, or instead, include a logistic regression model, support vector machine, decision tree, random forest, gradient boosted tree, naïve Bayes classifier, Bayesian network, hierarchical model, ensemble model, and/or another type of machine learning model that does not include artificial neural network components.

In one or more embodiments, machine learning model 308 is trained to generate predictions 316 of labels 312 assigned to images 310 in a training dataset 302. For example, assume that machine learning model 308 is a CNN and that training dataset 302 includes images 310 of 10 handwritten digits ranging from 0 to 9, as well as labels 312 that identify one of the 10 digits to which each of the corresponding images 310 belongs. In such a case, during training of machine learning model 308, a training technique, such as stochastic gradient descent and backpropagation, could be used to update weights of the CNN in a manner that reduces errors between predictions 316 generated by the CNN from input images 310 and the corresponding labels 312. After training of machine learning model 308 is complete, the trained machine learning model 308 can be used to generate additional predictions 316 of classes represented by labels 312 for images that are not in training dataset 302. Continuing with the above example, the trained machine learning model 308 could be applied to an input image to generate a set of 10 confidence scores for 10 classes representing 10 different handwritten digits. Each confidence score could range from 0 to 1 and represent a probability or another measure of certainty that the input image belongs to a certain class (i.e., that the input image is of a certain handwritten digit), and all confidence scores could sum to 1. When a confidence score output by machine learning model 308 for the input image exceeds a threshold, the input image could be determined to be from the corresponding class.

Illustratively, processing engine 114 generates simplified model 304 based on predictions 316 generated by machine learning model 308 from images 310 in training dataset 302. During the generation of simplified model 304, processing engine 114 identifies a set of representative images 314 in training dataset 302 for each class predicted by machine learning model 308. In some embodiments, representative images 314 include images 310 in training dataset 302 that are “typical” or unambiguous examples of classes or categories represented by the corresponding labels 312. For example, representative images 314 assigned to a label representing a specific handwritten digit could include images 310 in training dataset 302 that are associated with high confidence scores output by machine learning model 308 for that handwritten digit. Processing engine 114 could identify these representative images 314 by applying one or more thresholds to confidence scores generated by machine learning model 308 for images 310 assigned to the label. The thresholds could include (but are not limited to) a minimum threshold (e.g., 0.8, 0.9, 0.95, etc.) for a confidence score associated with the handwritten digit and/or a maximum threshold (e.g., 0.1, 0.05, etc.) for confidence scores for all other handwritten digits. Processing engine 114 could also use these thresholds to identify additional sets of representative images 314 for other labels 312 in training dataset 302. As a result, processing engine 114 could generate 10 sets of representative images 314 for 10 different handwritten digits ranging from 0 to 9.

In some embodiments, representative images 314 include images that are not found in training dataset 302. Continuing with the above example, representative images 314 for a given class could include additional images for which the trained machine learning model 308 generates confidence scores that meet the minimum and/or maximum thresholds. These additional images could also, or instead, be validated by one or more humans as belonging to the class before the additional images are added to the set of representative images 314 for the class.

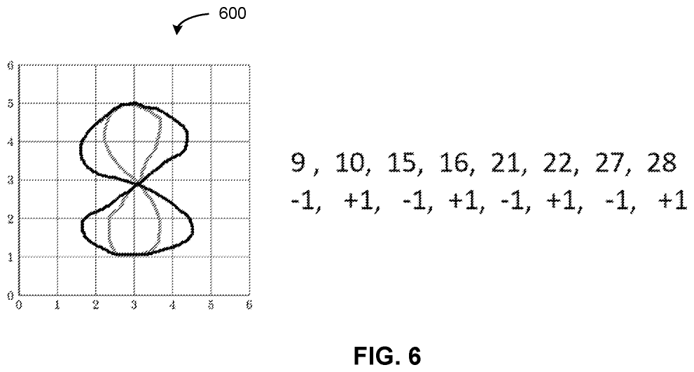

Processing engine 114 also generates compact representations 320(1)-320(N) of representative images 314 for different classes 322(1)-322(N) represented by labels 312 in training dataset 302. Each of compact representations 320(1)-320(N) is referred to individually as compact representation 320, and each of classes 322(1)-322(N) is referred to individually as class 322. A given compact representation 320 indicates a list of valid pixel indices having one or more pixel values associated with a particular set of representative images 314. For example, a given compact representation 320 could include a list of valid pixel index ranges in representative images 314 for a corresponding class. Returning to the example of hand-drawn digits, a compact representation of a particular digit could include ranges of pixels having a value of 1 (as opposed to 0) in representative images of the particular digit, as discussed in greater detail below in conjunction with FIG. 6.

Processing engine 114 can also generate multiple compact representations 320 of representative images 314 for each class 322. For example, processing engine 114 could divide a set of representative images 314 for a given class 322 into multiple subsets of representative images 314 for the same class 322. These subsets of images can then be degraded incrementally to stretch the typicality vectors of representative images 314. Processing engine 114 could then generate ranges of pixel indices lists for each subset of representative images 314.

To generate simplified model 304, processing engine 114 populates simplified model 304 with mappings of compact representations 320 to the corresponding classes 322. Each mapping indicates that machine learning model 308 predicts a certain class 322 for a set of images from which a corresponding compact representation 320 was generated. For example, processing engine 114 could store a mapping of each compact representation 320 to a corresponding class 322 in a lookup table, database, file, key-value store, and/or another type of data store or structure corresponding to simplified model 304.

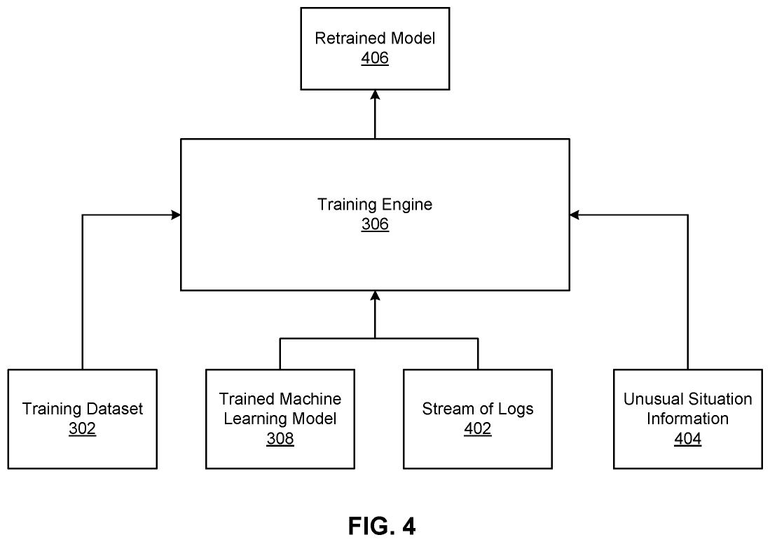

Once generated, simplified model 304 can be deployed to an edge device (e.g., edge device 130) and executed by the model runtime (e.g., model runtime 140) thereon to perform inference for new data, such as a new image. Processing engine 114 can also update machine learning model 308 and/or simplified model 304 based on data received from the edge device. As discussed in greater detail below in conjunction with FIGS. 4-9, in some embodiments, model runtime 140 communicates to processing engine 114 a stream of logs and information indicating unusual situations that are encountered during execution of simplified model 304. For example, the stream of logs can include sensor data (e.g., images), and the unusual situations can include situations that simplified model 304 was unable to handle and/or was unable to handle with sufficiently high confidence. In turn, processing engine 114 can add at least a portion of the received data as one or more records to training dataset 302. Thereafter, training engine 306 in processing engine 114 can re-train machine learning model 308 using the one or more records. In addition, processing engine 114 can update compact representations 320 and/or classes 322 to which compact representations 320 are mapped based on predictions 316 output by the re-trained machine learning model and/or images 310 and labels 312 that have been added to training dataset 302. Consequently, the accuracy of machine learning model 308 and/or simplified model 304 can be improved.

FIG. 4 is a more detailed illustration of training engine 306 in processing engine 114 of FIG. 3, according to various embodiments. As shown, inputs to training engine 306 include a previously trained machine learning model 308, a stream of logs 402, and information indicating unusual situations 404 encountered during execution of simplified model 304 on one or more edge devices (e.g., edge device 130). As described, trained machine learning model 308 can be any technically feasible machine learning model. In some embodiments, trained machine learning model 308 can include a recurrent neural network (RNN), convolutional neural network (CNN), deep neural network (DNN), deep convolutional networks (DCN), deep belief networks (DBN), restricted Boltzmann machine (RBM), long-short-term memory (LSTM) unit, gated recurrent units (GRU), generative adversarial networks (GAN), self-organizing map (SOM), and/or other type of artificial neural network or component of artificial neural network. In some other embodiments, trained machine learning model 308 includes functionality to perform clustering, principal component analysis (PCA), latent semantic analysis (LSA), Word2vec, and/or another unsupervised or self-supervised learning technique. In some other embodiments, trained machine learning model 308 can include a regression model, support vector machine, decision tree, random forest, gradient boosted tree, naïve Bayes classifier, Bayesian network, hierarchical model, and/or ensemble model.

Stream of logs 402 can include any suitable data that is useful for re-training trained machine learning model 308 and that is logged during execution of simplified model 304 on one or more edge devices. In some embodiments, stream of logs 402 can include sensor data (e.g., images) that was acquired by sensors of the edge device(s) and/or related information such as predictions made using simplified model 304 given the sensor data, which can be used to re-trained trained machine learning model 308.

Unusual situation information 404 can include any suitable information that indicates unusual situations encountered during execution of simplified model 304 on one or more edge devices. In some embodiments, the unusual situations can indicate inputs (e.g., images) that simplified model 304 was unable to process and/or was unable to process with sufficiently high confidence. In some embodiments, unusual situation information 404 can also include sensor data (e.g., images) associated with the unusual situations. In some embodiments, only a portion of data that processing engine 114 receives from edge device(s), such as data that was not previously used to train machine learning model 308 and/or data associated with unusual situations that simplified model 304 was unable to handle, is used to re-train machine learning model 308 so that the re-trained machine learning model can handle the unusual situations. In some embodiments, one or more monitoring engines 116 can also receive stream of logs 402 and unusual situation information 404 and use such information to monitor the performance of simplified model 304. For example, in some embodiments, the monitoring engine(s) 116 can monitor simplified model 304 to identify a reduction in performance, such as model drift. As another example, in some embodiments, the monitoring engine(s) 116 can monitor sensor data that is input into simplified model 304 to determine whether the sensor data differs from data that was used to train machine learning 308, from which simplified model 304 was generated. In such cases, if the monitoring engine(s) 116 identify a reduction in performance and/or that the sensor data differs from data that was used to train machine learning model 308, then monitoring engine(s) 116 can trigger one or more training engines 306 to re-train machine learning model 308.

In some embodiments, stream of logs 402 and unusual situation information 404 can be transmitted from one or more edge devices that generate such data to processing engine 114 in real-time, offline, or in batch jobs. Illustratively, given trained machine learning model 308, stream of logs 402, and unusual situation information 404, training engine 306 updates trained machine learning model 308 by re-training and/or fine-tuning trained machine learning model 308. The training engine 306 can re-train trained machine learning model 308 in any technically feasible manner in some embodiments, and the technique(s) used to re-train trained machine learning model 308 will generally depend on the type of trained machine learning model 308. For example, when the trained machine learning model 308 is a neural network, training engine 306 can perform a stochastic gradient descent and backpropagation technique to re-train trained machine learning model 308 using at least a portion of data from stream of logs 402 and/or unusual situation information 404 as training data.

FIG. 5 is a more detailed illustration of edge device 130 of FIG. 1, according to various embodiments. As shown, edge device 130 includes a computing unit 132, one or more sensors 134, and one or more output devices 136. As described above in conjunction with FIG. 1, each sensor 134 can include any device or component configured to detect, measure, or respond to physical, chemical, or biological changes or inputs in an environment, and each output device 136 can include a hardware system or device configured to convey information, data, or results to user(s) or other system(s) in a tangible or perceivable form. In some embodiments, sensor(s) 134, output device(s) 136, and control unit 132 can be in one integrated device, e.g., a headlight and an electronic control unit (ECU) of the headline. In some other embodiments, a single control unit can control more than one set of sensors and/or output devices.

Computing unit 132 includes hardware devices to process data and to communicate with sensors 134, output devices 136, and cloud computing environment 110. Illustratively, computing unit 132 includes a CPU 502, system memory 504, and a network interface 506, which in some embodiments can be similar to the CPU 202, system memory 204, and network adapter 218 of compute node 112, described above in conjunction with FIG. 2.

In operation, model runtime 140 is loaded into system memory 504 and executes on CPU 202. Model runtime 140 executes simplified model 142 and communicates with other devices and systems, such as sensors that acquire data that is input into simplified model 142, output devices being controlled by model runtime 140, another system that controls output devices, and/or a processing engine 114. In particular, model runtime 140 can communicate a stream of logs and unusual situation information, described above in conjunction with FIG. 4, to a processing engine 114. The stream of logs and unusual situation information can be communicated in real time, offline, or in batch jobs in some embodiments. In turn, the processing engine 114 can re-train machine learning model 308 using the stream of logs and unusual situation information.

Model runtime 140 also executes simplified model 142 to process sensor data (e.g., images) received by control unit 132. In addition, model runtime 140 can transmit any actions generated using simplified model 142, or generated from outputs of simplified model 142, to output devices 136 or another controller of output devices. For example, in some embodiments, when the sensor data includes an image, model runtime 508 can perform comparisons and/or evaluations involving pixels in the image and compact representations of pixel ranges in simplified model 304. Then, model runtime 508 can use the results of the comparisons and/or evaluations to generate a compact representation match for the image. The compact representation match can include one or more compact representations of simplified model 142 for which pixel values of the image are within the ranges of pixel values in the one or more compact representations.

FIG. 6 illustrates how a machine learning model can be simplified, according to various embodiments. As described in conjunction with FIG. 3, in order to generate a simplified model, processing engine 114 can determine representative images 314 for each object class that can be predicted by a machine learning model. The representative images are the most typical images for the corresponding object class. FIG. 6 shows an example of one object class for the number 8 and two variations of the object class.

Illustratively, the number 8 can be represented in a 6×6 grid 600 of pixels. Given 6×6 images of the number 8, processing engine 114 generates a list of pixel indices associated with the object class in the images. In the illustrated example, the pixel indices start from the top left of each image and increase from left to right and from top to bottom. As shown, pixel indices 9, 10, 15, 16, 21, 22, 27, and 28 are associated with particular pixel values (e.g., 1) for one typical image of the number 8 that the trained machine learning model 308 can predict with a sufficiently high confidence. In addition, processing engine 114 calculates acceptable ranges of pixel indices for images that are typical for the number 8. Illustratively, the +1 and −1 in FIG. 6 represent acceptable ranges for corresponding pixel indices. For example, the pixel index 9 is associated with −1, indicating that pixel index 8 is within the same range, etc. Processing engine 114 generates a list of pixel ranges for all representative images 314 in each class, and mappings of the list of pixel ranges for each class to the classes are included in a simplified model that can be used to classify images into the classes based on pixel values falling within corresponding pixel ranges for those classes, as indicated by the lists of pixel ranges. In some embodiments, processing engine 114 can also distort typical images of 8's and other object classes and generate the pixel ranges based on the distorted typical images. Doing so essentially expands the range of what is considered an 8, which will permit the simplified model to handle more cases, including images of distorted 8's and the other object classes.

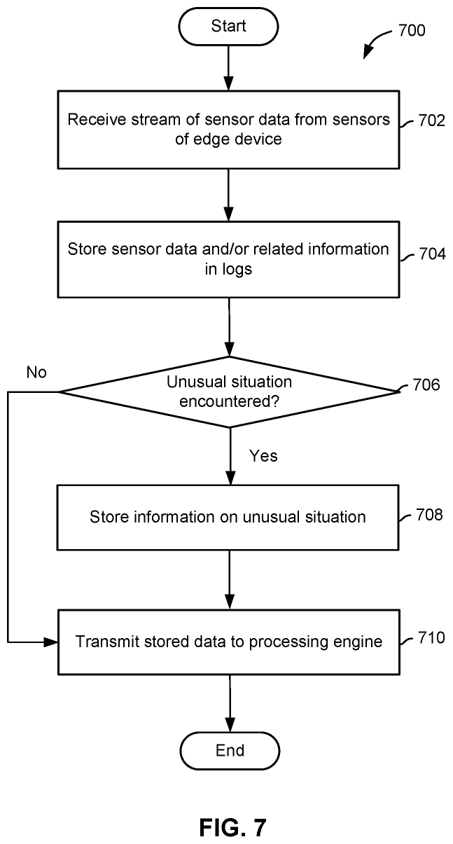

FIG. 7 sets forth a flow diagram of method steps for acquiring data to re-train a machine learning model, according to various embodiments. Although the method steps are described in conjunction with FIGS. 1-5, persons skilled in the art will understand that any system configured to perform the method steps, in any order, falls within the scope of the present disclosure.

As shown, a method 700 begins at step 702, where computing unit 132 receives a stream of sensor data from sensor(s) of edge device 130.

At step 704, model runtime 140 stores the sensor data and/or related information in one or more logs. Any suitable related information can be stored, such as predictions by simplified model 304 based on the sensor data, times when sensor data was received, etc.

At step 706, model runtime 140 determines whether an unusual situation has been encountered. As described, in some embodiments, unusual situations can include receiving sensor data that simplified model 304 is unable to process and/or is unable to process with sufficiently high confidence.

If model runtime 140 determines at step 706 that an unusual situation has been encountered, then method 700 continues to step 708, where model runtime 140 stores information on the unusual situation.

On the other hand, if model runtime 140 determines at step 706 that an unusual situation has not been encountered, or after model runtime 140 stores the information indicating the unusual situation at step 708, then model runtime 140 transmits the stored data to processing engine 114 at step 710. In some embodiments, the stored data can be transmitted in real-time, offline, and/or in batch jobs.

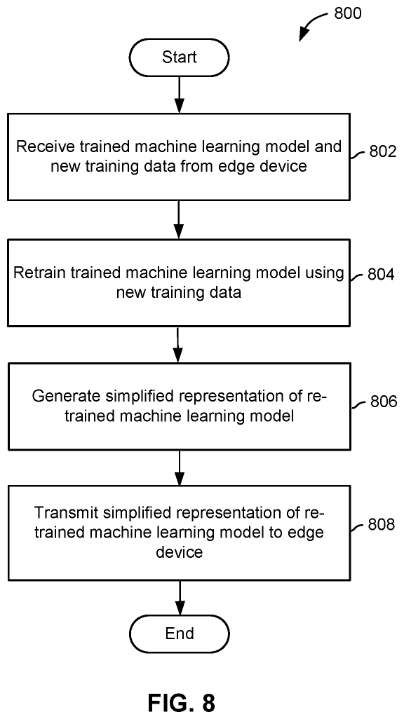

FIG. 8 sets forth a flow diagram of method steps for updating a simplified machine learning model on an edge device, according to various embodiments. Although the method steps are described in conjunction with FIGS. 1-5, persons skilled in the art will understand that any system configured to perform the method steps, in any order, falls within the scope of the present disclosure.

As shown, a method 800 begins at step 802, where training engine 402 receives a trained machine learning model 308 and new training data from model runtime 140. As described, in some embodiments, the new training data can include sensor data (e.g., images, videos, etc.) from a stream of logs and/or unusual situation information that is received from model runtime 140. In some embodiments, trained machine learning model 308 can be re-trained using all of the new data received from model runtime 140. In some embodiments, trained machine learning model 308 can be re-trained using only a portion of the new data received from model runtime 140, such as only data that differs from data previously used to train machine learning model 308 and/or data associated with unusual situations that simplified model 142 was unable to process or unable to process with sufficiently high confidence.

At step 804, training engine 402 re-trains the trained machine learning model 308 using the new training data. In some embodiments, the trained machine learning 308 model can be re-trained in any technically feasible manner, such as via techniques as described above in conjunction with FIG. 3.

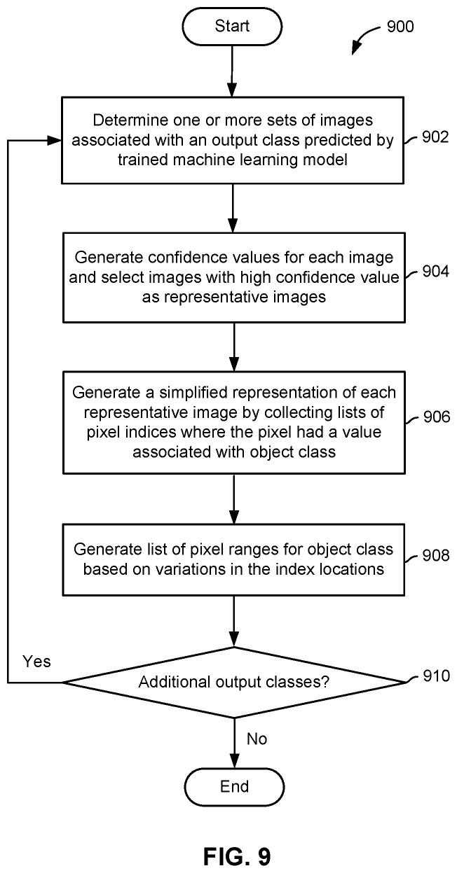

At step 806, processing engine 114 generates a simplified representation of the re-trained machine learning model. In some embodiments, processing engine 114 can generate the simplified representation of the re-trained machine learning model according to steps of method 900 for simplifying a machine learning model, discussed below in conjunction with FIG. 9.

At step 808, processing engine 114 transmits the simplified representation of the re-trained machine learning model to the edge device for execution by a model runtime on the edge device.

FIG. 9 sets forth a flow diagram of method steps for simplifying a machine learning model, according to various embodiments. Although the method steps are described in conjunction with FIGS. 1-5, persons skilled in the art will understand that any system configured to perform the method steps, in any order, falls within the scope of the present disclosure.

As shown, a method 900 begins at step 902, where processing engine 114 selects one or more sets of images from training dataset 302 associated with an output class predicted by a trained machine learning model.

At step 904, processing engine 114 uses the trained machine learning model to generate confidence values for each image and selects one or more images with the high confidence values (or confidence values above a threshold) as representative images that are most typical for the image class.

At step 906, processing engine 114 generates a simplified representation for each representative image in the form of a list of location indices where pixels had values associated with the object class. Step 906 can be repeated for all representative images in the class.

At step 908, processing engine 114 generates a list of pixel ranges for the object class based on variations in the index locations determined at step 906. An example list of pixel ranges is described above in conjunction with FIG. 6.

At step 910, if there are additional output classes of the trained machine learning model to process, then method 900 returns to step 902. Otherwise, if there are no additional output classes to process, then method 900 ends.

In sum, techniques are disclosed for simplifying machine learning models so that the simplified machine learning models can be deployed to run on edge devices, as well as managing the lifecycles of simplified machine learning running on edge devices. In some embodiments, a model runtime executes a simplified machine learning model on an edge device. The model runtime is in communication with a processing engine, which can execute in a server or cloud, and the model runtime transmits to the processing engine a stream of logs and information indicating unusual situations encountered during execution of the simplified machine learning model. In turn, the processing engine uses the logs and unusual situation information to re-train a machine learning model that was used to generate the simplified machine learning model. The processing engine then simplifies the re-trained machine learning model to generate an updated simplified machine learning model. Thereafter, the processing engine transmits the updated simplified machine learning model to the edge device for execution by the model runtime. In addition, a monitoring engine can monitor the updated simplified machine learning model for drift based on additional logs and unusual situation information received from the model runtime. In turn, the processing engine can re-train the machine learning model based on the additional logs and unusual situation information, generate another updated simplified machine learning model, and deploy the updated simplified machine learning model to the edge device.

In some embodiments in which a machine learning model is used to classify objects in images, the machine learning model can be simplified by selecting images with high confidence for each class of objects that is output by the machine learning model. Based on the selected images, a list of location indices is created for pixels with values associated with the object in the images. For each class of objects, a range representation is generated based on variations in the indices of the selected images for the class of objects. The range representations for the classes of objects can then be included in a simplified machine learning model.

One technical advantage of the disclosed techniques relative to the prior art is that the simplified machine learning models require less computational resources and can, therefore, run on edge devices. The simplified machine learning models also do not have significantly reduced performance relative to the performance of the original machine learning models. In addition, the disclosed techniques permit the lifecycles of simplified machine learning models to be managed, including updating the simplified machine learning models and deploying the updated simplified machine learning models to edge devices. These technical advantages provide one or more technological improvements over prior art approaches.

1. In some embodiments, a computer-implemented method for updating a simplified representation of a machine learning model comprises receiving, from an edge device, data associated with execution of the simplified representation of the machine learning model on the edge device, performing one or more operations to re-train the machine learning model based on at least a portion of the data to generate a re-trained machine learning model, generating a simplified representation of the re-trained machine learning model, and transmitting, to the edge device, the simplified representation of the re-trained machine learning model for execution on the edge device.

2. The computer-implemented method of clause 1, wherein the data associated with execution of the simplified representation of the machine learning model includes sensor data acquired using one or more sensors included in the edge device.

3. The computer-implemented method of clauses 1 or 2, wherein the data associated with execution of the simplified representation of the machine learning model indicates at least one situation during which the simplified representation of the machine learning model was either unable to generate an output or unable to generate an output with sufficiently high confidence.

4. The computer-implemented method of any of clauses 1-3, wherein the at least a portion of the data includes data that is not included in training data previously used to train the machine learning model.

5. The computer-implemented method of any of clauses 1-4, wherein the simplified representation of the re-trained machine learning model includes a mapping of one or more ranges of values to an output class of the re-trained machine learning model.

6. The computer-implemented method of any of clauses 1-5, wherein generating the simplified representation of the re-trained machine learning model comprises determining a set of images associated with an output class of the re-trained machine learning model, generating an aggregated representation of the first set of images, wherein the aggregated representation comprises one or more ranges of pixel values associated with the set of images, and generating the simplified representation of the re-trained machine learning model that includes a mapping of the first aggregated representation to the output class.

7. The computer-implemented method of any of clauses 1-6, further comprising receiving, from the edge device, data associated with execution of the simplified representation of the re-trained machine learning model on the edge device, and computing at least one performance metric for the simplified representation of the re-trained machine learning model based on the data associated with execution of the simplified representation of the re-trained machine learning model.

8. The computer-implemented method of any of clauses 1-7, wherein the data is received from the edge device either in real time, offline, or in batches.

9. The computer-implemented method of any of clauses 1-8, wherein the edge device is incapable of executing the re-trained machine learning model.

10. The computer-implemented method of any of clauses 1-9, wherein the re-trained machine learning model comprises an artificial neural network.

11. In some embodiments, one or more non-transitory computer-readable media store program instructions that, when executed by at least one processor, cause the at least one processor to perform the steps of receiving, from an edge device, data associated with execution of a simplified representation of a machine learning model on the edge device, performing one or more operations to re-train the machine learning model based on at least a portion of the data to generate a re-trained machine learning model, generating a simplified representation of the re-trained machine learning model, and transmitting, to the edge device, the simplified representation of the re-trained machine learning model for execution on the edge device.

12. The one or more non-transitory computer-readable media of clause 11, wherein the data associated with execution of the simplified representation of the machine learning model includes sensor data acquired using one or more sensors included in the edge device.

13. The one or more non-transitory computer-readable media of clauses 11 or 12, wherein the data associated with execution of the simplified representation of the machine learning model indicates at least one situation during which the simplified representation of the machine learning model was either unable to generate an output or unable to generate an output with sufficiently high confidence.

14. The one or more non-transitory computer-readable media of any of clauses 11-13, wherein the at least a portion of the data includes data that is not included in training data previously used to train the machine learning model.

15. The one or more non-transitory computer-readable media of any of clauses 11-14, wherein the simplified representation of the re-trained machine learning model includes a mapping of one or more ranges of values to an output class of the re-trained machine learning model, and the one or more ranges of values are determined based on the at least a portion of the data and training data previously used to train the machine learning model.

16. The one or more non-transitory computer-readable media of any of clauses 11-15, wherein the one or more ranges of values includes one or more ranges of image pixels that are associated with the output class.

17. The one or more non-transitory computer-readable media of any of clauses 11-16, wherein the one or more ranges of values are determined based an expansion of one or more intermediate ranges of values that are determined based on the at least a portion of the data and the training data previously used to train the machine learning model.

18. The one or more non-transitory computer-readable media of any of clauses 11-17, wherein the instructions, when executed by the at least one processor, further cause the at least one processor to perform the steps of receiving, from the edge device, data associated with execution of the simplified representation of the re-trained machine learning model on the edge device, and computing at least one performance metric for the simplified representation of the re-trained machine learning model based on the data associated with execution of the simplified representation of the re-trained machine learning model.

19. The one or more non-transitory computer-readable media of any of clauses 11-18, wherein the data is received from the edge device either in real time, offline, or in batches.

20. In some embodiments, a system comprises one or more memories storing instructions, and one or more processors that are coupled to the one or more memories and, when executing the instructions, are configured to receive, from an edge device, data associated with execution of a simplified representation of a machine learning model on the edge device, perform one or more operations to re-train the machine learning model based on at least a portion of the data to generate a re-trained machine learning model, generate a simplified representation of the re-trained machine learning model, and transmit, to the edge device, the simplified representation of the re-trained machine learning model for execution on the edge device.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments can be embodied as a system, method or computer program product. Accordingly, aspects of the present disclosure can take the form of an entirely hardware embodiment, an entirely software embodiment (including firmware, resident software, micro-code, etc.) or an embodiment combining software and hardware aspects that can all generally be referred to herein as a “module” or “system.” Furthermore, aspects of the present disclosure can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors can be, without limitation, general purpose processors, special-purpose processors, application-specific processors, or field-programmable.

The flowchart and block diagrams in the figures illustrate the architecture, functionality, and operation of possible implementations of systems, methods and computer program products according to various embodiments of the present disclosure. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure can be devised without departing from the basic scope thereof, and the scope thereof is determined by the claims that follow.

What is claimed is:

1. A computer-implemented method for updating a simplified representation of a machine learning model, the method comprising:
receiving, from an edge device, data associated with execution of the simplified representation of the machine learning model on the edge device;
performing one or more operations to re-train the machine learning model based on at least a portion of the data to generate a re-trained machine learning model;
generating a simplified representation of the re-trained machine learning model; and
transmitting, to the edge device, the simplified representation of the re-trained machine learning model for execution on the edge device.

2. The computer-implemented method of claim 1, wherein the data associated with execution of the simplified representation of the machine learning model includes sensor data acquired using one or more sensors included in the edge device.

3. The computer-implemented method of claim 1, wherein the data associated with execution of the simplified representation of the machine learning model indicates at least one situation during which the simplified representation of the machine learning model was either unable to generate an output or unable to generate an output with sufficiently high confidence.

4. The computer-implemented method of claim 1, wherein the at least a portion of the data includes data that is not included in training data previously used to train the machine learning model.

5. The computer-implemented method of claim 1, wherein the simplified representation of the re-trained machine learning model includes a mapping of one or more ranges of values to an output class of the re-trained machine learning model.

6. The computer-implemented method of claim 1, wherein generating the simplified representation of the re-trained machine learning model comprises:
determining a set of images associated with an output class of the re-trained machine learning model;
generating an aggregated representation of the first set of images, wherein the aggregated representation comprises one or more ranges of pixel values associated with the set of images; and
generating the simplified representation of the re-trained machine learning model that includes a mapping of the first aggregated representation to the output class.

7. The computer-implemented method of claim 1, further comprising:
receiving, from the edge device, data associated with execution of the simplified representation of the re-trained machine learning model on the edge device; and
computing at least one performance metric for the simplified representation of the re-trained machine learning model based on the data associated with execution of the simplified representation of the re-trained machine learning model.

8. The computer-implemented method of claim 1, wherein the data is received from the edge device either in real time, offline, or in batches.

9. The computer-implemented method of claim 1, wherein the edge device is incapable of executing the re-trained machine learning model.

10. The computer-implemented method of claim 1, wherein the re-trained machine learning model comprises an artificial neural network.

11. One or more non-transitory computer-readable media storing program instructions that, when executed by at least one processor, cause the at least one processor to perform the steps of:
receiving, from an edge device, data associated with execution of a simplified representation of a machine learning model on the edge device;
performing one or more operations to re-train the machine learning model based on at least a portion of the data to generate a re-trained machine learning model;
generating a simplified representation of the re-trained machine learning model; and
transmitting, to the edge device, the simplified representation of the re-trained machine learning model for execution on the edge device.

12. The one or more non-transitory computer-readable media of claim 11, wherein the data associated with execution of the simplified representation of the machine learning model includes sensor data acquired using one or more sensors included in the edge device.

13. The one or more non-transitory computer-readable media of claim 11, wherein the data associated with execution of the simplified representation of the machine learning model indicates at least one situation during which the simplified representation of the machine learning model was either unable to generate an output or unable to generate an output with sufficiently high confidence.

14. The one or more non-transitory computer-readable media of claim 11, wherein the at least a portion of the data includes data that is not included in training data previously used to train the machine learning model.

15. The one or more non-transitory computer-readable media of claim 11, wherein the simplified representation of the re-trained machine learning model includes a mapping of one or more ranges of values to an output class of the re-trained machine learning model, and the one or more ranges of values are determined based on the at least a portion of the data and training data previously used to train the machine learning model.

16. The one or more non-transitory computer-readable media of claim 15, wherein the one or more ranges of values includes one or more ranges of image pixels that are associated with the output class.

17. The one or more non-transitory computer-readable media of claim 15, wherein the one or more ranges of values are determined based an expansion of one or more intermediate ranges of values that are determined based on the at least a portion of the data and the training data previously used to train the machine learning model.

18. The one or more non-transitory computer-readable media of claim 11, wherein the instructions, when executed by the at least one processor, further cause the at least one processor to perform the steps of:
receiving, from the edge device, data associated with execution of the simplified representation of the re-trained machine learning model on the edge device; and
computing at least one performance metric for the simplified representation of the re-trained machine learning model based on the data associated with execution of the simplified representation of the re-trained machine learning model.

19. The one or more non-transitory computer-readable media of claim 11, wherein the data is received from the edge device either in real time, offline, or in batches.

20. A system, comprising:
one or more memories storing instructions; and
one or more processors that are coupled to the one or more memories and,
when executing the instructions, are configured to:
receive, from an edge device, data associated with execution of a simplified representation of a machine learning model on the edge device,
perform one or more operations to re-train the machine learning model based on at least a portion of the data to generate a re-trained machine learning model,
generate a simplified representation of the re-trained machine learning model, and
transmit, to the edge device, the simplified representation of the re-trained machine learning model for execution on the edge device.
